(19) United States
(12) Patent Application Publication
(10) Pub. No.: US 2007/0031690 A1
(43) Pub. Date: Feb. 8, 2007

(54) Multilayer coextruded films including frangible intralaminar bonding forces

(75) Inventors: David A. Busche, Neenah, WI (US); Gregory R. Pockat, Ripon, WI (US)

Correspondence Address: BEMIS COMPANY, INC., 2200 BADGER AVENUE, OSHKOSH, WI, 54904, US

(73) Assignee: Curwood, Inc., Oshkosh, WI (US)

(21) Appl. No.: 11/198,809

(22) Filed: Aug. 5, 2005

(51) Int. Cl. B32B 27/34

(52) U.S. Cl. 428/474.4

(57) ABSTRACT

Multilayer film structures are disclosed having a first layer of polymer sealant material, a second layer comprising a frangible bond layer, and a third layer comprising an adhesive or polyolefin. The first layer comprises from about 1% to about 10% of the total thickness of the multilayer film structure, has a maximum thickness of about 0.25 mils. and has a thickness uniformity deviation of less than about 20% of the average thickness of the first layer.

### BACKGROUND OF THE INVENTION

The present disclosure relates to multilayer thermoplastic film structures for packaging film applications. Particularly, the disclosure relates to multilayer coextruded packaging films including frangible intralaminar bonding that allows packages made therefrom to be opened with manual forces.

Multilayer thermoplastic film structures are used to package food and medicinal articles, to protect the articles against external contamination and abuse, and to provide an attractive package for the article for its eventual sale. There is great commercial interest in the packaging industry for a multilayer film structure that provides superior mechanical strength, better optical and gas barrier properties, and improved means for opening packages without the aid of a knife or cutting implement or without uncontrolled or random tearing. Packaging films are desired, including one or more of these properties that is openable without uncontrolled rupturing of the packaging materials, e.g., away from the seal area that may result in opening in an undesired location or in sudden destruction of the package and inadvertent contamination or spillage of the contents.

### SUMMARY OF THE DISCLOSURE

In a first aspect, the present disclosure is directed to a multilayer thermoplastic film structure comprising a first layer of polymer sealant material; a second layer comprising a frangible polymer blend comprising at least a first polymeric component and a second polymeric component; a third layer of an adhesive material; a fourth layer of nylon; a fifth layer comprising either gas barrier material or an adhesive material; a sixth layer of nylon; a seventh layer of adhesive material; and an eighth layer selected from the group consisting of nylon, polyester and polyolefin, wherein the multilayer thermoplastic film structure is formed into a flexible film by a coextrusion process.

In a second aspect, the present disclosure is directed to a multilayer thermoplastic film structure comprising a first layer of polymer sealant material; a second layer comprising a frangible polymer blend, comprising at least a first polymeric component and a second polymeric component; a third layer of polyolefin; a fourth layer of adhesive material; a fifth layer of nylon; a sixth layer comprising either an oxygen barrier material or an adhesive material; a seventh layer of nylon; an eighth layer of adhesive material; and a ninth layer selected from the group consisting of nylon, polyester and polyolefin, wherein the multilayer thermoplastic film structure is formed into a flexible film by a coextrusion process.

In a third aspect, the present disclosure is directed to a package formed of a multilayer thermoplastic film structure as set forth above in connection with the first or second aspect that is heat-sealed to a second film.

### BRIEF DESCRIPTION OF THE DRAWINGS

FIG. 1 is a cross-sectional view of a multilayer structure having eight layers according to the present disclosure.

FIG. 2 is a cross-sectional view of a multilayer structure having eight layers according to the present disclosure.

FIG. 3 is a cross-sectional view of a multilayer structure having nine layers according to the present disclosure.

FIG. 4 is a cross-sectional view of a multilayer structure having nine layers according to the present disclosure.

### DETAILED DESCRIPTION OF THE DISCLOSURE

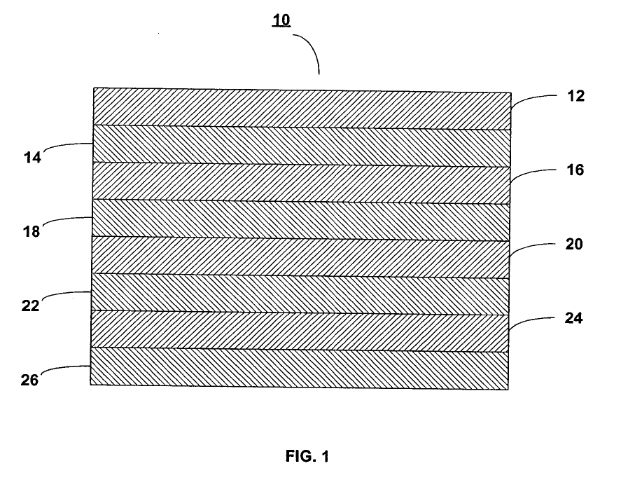

With reference to the drawings, there is seen in FIG. 1 a multilayer film structure 10 having a first layer 12, a second layer 14, a third layer 16, a fourth layer 18, a fifth layer 20, a sixth layer 22, a seventh layer 24 and an eighth layer 26. First layer 12 of the multilayer film structure 10 comprises a polymer sealant material. As used herein, the term “sealant” refers to a layer which is heat sealable to itself or other layers, i.e., is capable of fusion bonding by conventional indirect heating means which generate sufficient heat on at least one film contact surface for conduction to the contiguous film contact surface and formation of a bond interface therebetween without loss of the film integrity. Advantageously, the bond interface must be sufficiently thermally stable to prevent gas or liquid leakage therethrough.

Examples of suitable polymer sealant materials for the first layer 12 include a sealant selected from a group consisting of ionomer, polyethylene, including heterogeneous ethylene-alpha olefin copolymer, homogeneous ethylene-alpha olefin copolymer, low-density polyethylene (LDPE), linear low-density polyethylene (LLDPE), and ultra low-density polyethylene (ULDPE), ethylene vinyl acetate copolymer (EVA), ethylene methyl acrylate copolymer, ethylene propylene copolymer, polypropylene homopolymer and copolymer, polybutylene homopolymer and copolymer, propylene-alpha olefin copolymers, polyethylene terephthalate, nylon, and blends thereof.

The second layer 14 is a frangible polymer blend selected to provide the multilayer film structure 10 with an internally frangible failure mechanism. The second layer 14 has a maximum thickness of about 0.5 mils. and preferably comprises from about 1% to about 20% of the total thickness of the multilayer structure. The second layer 14 comprises a polymer blend of at least a first polymeric component and a second polymeric component selected such that the interfacial bond forces between the second layer 14 and the first layer 12, or between the second layer 14 and the third layer 16, or the internal cohesive bond within the blend are lower than a heat seal formed between the first layer 12 and a sealant layer of another film to which the multilayer film structure 10 is ultimately sealed. The first polymeric component may be selected from polyolefin, such as polyethylene which includes, but is not limited to, low-density polyethylene, linear low-density polyethylene, ultra low-density polyethylene, medium-density polyethylene, ethylene-alpha olefin copolymers (EAO), cyclic olefin copolymers (COC), ethylene vinyl esters, especially ethylene vinyl acetate copolymers (EVA), ionomer, adhesive material and blends thereof. An adhesive material, as used herein, refers to any polymeric material serving a primary purpose or function of adhering two surfaces to one another. In the present invention, an adhesive material may adhere one film layer surface to another film layer surface (presumably, across their entire surface areas). The adhesive material may comprise any polymer, copolymer or blend of polymers having a polar group thereon, or any other polymer, homopolymer, copolymer or blend of polymers, including modified and unmodified polymers, e.g., grafted copolymers, which provide sufficient interlayer adhesion to adjacent layers comprising otherwise non-adhering polymers. Adhesive materials may include, but are not limited to, modified and unmodified homopolymer or copolymer of polyolefin, preferably modified polyethylene, and modified or unmodified homopolymer or copolymer of alkyl acrylates such as methyl acrylate, ethyl acrylate, n-butyl acrylate. Preferably, the first polymeric component is selected from EVA, ionomer, and ultra low-density polyethylene.

The second polymeric component of the second layer 14 is selected from materials that modify the bonding characteristics of the second layer 14 to create an internal frangible structure. The second polymeric component may be selected from polybutylene, polypropylene, high-density polyethylene or any suitable extrudable polymer that provides the second layer 14 with the desired properties. Preferably, the second polymeric component is polybutylene. A particularly preferred second layer 14 comprises EVA and polybutylene. The second layer 14 preferably comprises from about 5% by weight to about 30% by weight of second polymeric component. Preferably, a blend of about 85% by weight of the first polymeric component to about 15% by weight of the second polymeric component is used.

The third layer 16 is an adhesive material selected from the group consisting of a modified or unmodified homopolymer or copolymer of polyethylene, especially ethylene copolymers, alkyl acrylates such as methyl acrylate, ethyl acrylate, n-butyl acrylate, or vinyl esters such as ethylene vinyl acetate, especially ethylene vinyl acetate copolymers, ethylene-alpha olefin (EAO) and blends thereof. The third layer 16 functions as an adhesive for bonding the second layer 14 and the fourth layer 18 together. The third layer functions as a bonding layer, i.e., to bond second layer 14 to fourth layer 18. Preferably the second and fourth layers 14 and 18 contact opposing sides of the third layer, but optionally one or more additional layers may be coextruded between the third and fourth layers 16 and 18, or the second and third layers 14 and 16. Examples of suitable commercially available adhesives are sold by Rohm and Haas, Philadelphia, Pa., U.S.A., under the trademark TYMOR® 72×06; Mitsui Petrochemical Industries, Ltd. of Tokyo, Japan, under the trademark ADMER™ SF700; and du Pont de Nemours and Company, Wilmington, Del., U.S.A., under the trademark BYNEL® 41E687.

“Olefin” is used herein broadly to include polymers such as polyethylene, ethylene copolymers having a small amount of a copolymer such as vinyl acetate, ethylene-alpha olefin copolymers (LLDPE), polypropylene, polybutene, and other polymeric resins falling in the “olefin” family classification. The term “modified”, as used herein, refers to a chemical derivative, e.g., one having any form of anhydride functionality, such as anhydride of maleic acid, crotonic acid, citraconic acid, itaconic acid, fumaric acid, etc., whether grafted onto a polymer, copolymerized with a polymer, or blended with one or more polymers, and is also inclusive of derivatives of such functionalities, such as acids, esters, and metal salts derived therefrom.

The fourth layer 18 comprises nylon or nylon blend. Nylons suitable for use as the fourth layer 18 include nylon homopolymers and copolymers which may include, but are not limited to, a nylon selected from the group consisting of nylon 4,6 (poly(tetramethylene adipamide)), nylon 6 (polycaprolactam), nylon 6,6 (poly(hexamethylene adipamide)), nylon 6,9 (poly(hexamethylene nonanediamide)), nylon 6,10 (poly(hexamethylene sebacamide)), nylon 6,12 (poly(hexamethylene dodecanediamide)), nylon 6,12 (poly(caprolactam-co-dodecanediamide)), nylon 6,6/6 (poly(hexamethylene adipamide-co-caprolactam)), nylon 11 (polyundecanolactam), nylon 12 (polyauryllactam) and alloys or mixtures thereof. As used herein, terminology employing a “/” with respect to the chemical identity of any copolymer, e.g., nylon 6/12 (poly(caprolactam-co-dodecanediamide)), identifies the comonomers, in this case, caprolactam and dodecanediamide, which are copolymerized to produce the copolymer. It is appreciated by a person of ordinary skill in the art that the term “copolymer” refers to those copolymers where the first listed comonomer is polymerized in a higher weight percentage than the second listed comonomer.

Preferably, the third layer comprises between about 100% (wt.) to about 71% (wt.) of a nylon selected from the group consisting of nylon 4,6 (poly(tetramethylene adipamide)), nylon 6 (polycaprolactam), nylon 6,6 (poly(hexamethylene adipamide)), nylon 6,9 (poly(hexamethylene nonanediamide)), nylon 6,10 (poly(hexamethylene sebacamide)), nylon 6,12 (poly(hexamethylene dodecanediamide)), nylon 6/12 (poly(caprolactam-co-do-decanediamide)), nylon 6,6/6 (poly(hexamethylene adipamide-co-caprolactam)), nylon 11 (polyundecanolactam), nylon 12 (polyauryllactam) and alloys or mixtures thereof, blended with between about 0% (wt.) to about 29% (wt.) of an amorphous nylon. The generic source-based nomenclature convention is used to name the hereinabove nylon polymers and copolymers. See “Generic Source-Based Nomenclature for Polymers,” Pure Applied Chemistry, Vol. 73, No. 9, pp. 1511-1519 (International Union of Pure and Applied Chemistry 2001). Examples of commercially available nylons are sold under the trademarks ULTRAMID® C35 or ULTRAMID® B36 from BASF, Mount Olive, N.J., U.S.A., and 66 ZYTEL® 42A NCO10 from du Pont de Nemours and Company, Wilmington, Del., U.S.A. A commercial example of an amorphous nylon is sold under the trademark SELAR® PA 3426 from du Pont de Nemours and Company, Wilmington, Del., U.S.A.

As used herein, the term “amorphous nylon” refers to nylons with an absence of a regular three-dimensional arrangement of molecules or subunits of molecules extending over distances, which are large relative to atomic dimensions. However, regularity of structure exists on a local scale. See “Amorphous Polymers,” Encyclopedia of Polymer Science and Engineering, 2nd Ed., pp. 789-842 (John Wiley & Sons, Inc., 1985). In particular, the term “amorphous polyamide,” as used with respect to the present invention, refers to a material recognized by one skilled in the art of differential scanning calorimetry (DSC) as having no measurable melting point (less than 0.5 cal/g) or no heat of fusion as measured by DSC using ASTM 3417-83. Such nylons include those amorphous nylons prepared from condensation polymerization reactions of diamines with diacarboxylic acids.

The fifth layer 20 comprises a gas barrier layer. The fifth layer 20 is preferably an oxygen barrier layer selected from ethylene vinyl alcohol copolymer, polyvinylidene chloride copolymers, polyacrylonitrile, acrylonitrile copolymer, and blends thereof. A preferred oxygen barrier is an ethylene vinyl alcohol copolymer, which is commercially available under the trademark SOARNOL® ET3803 obtained from The Nippon Synthetic Chemical Industry Company, Ltd. (Nippon Gohsei), Osaka, Japan. A noteworthy characteristic of the multilayer film structure 10 where the fifth layer 20 is an oxygen barrier is that the film exhibits excellent oxygen barrier properties. It is appreciated by a person of ordinary skill in the art that a desirable oxygen property is one which minimizes the transmission of oxygen through the film. Oxygen permeation resistance or barrier may be measured using the procedure of ASTM D-3985 which method is hereby incorporated by reference. Accordingly, the multilayer film structure 10 formed into a flexible film where the fifth layer 20 is an oxygen barrier has an oxygen transmission rate less than about 15.5 cc/m² for 24 hours at 1 atmosphere.

The sixth layer 22 of multilayer film structure 10 comprises a nylon or nylon blend. The sixth layer 22 comprises a nylon selected form the group consisting of nylon 4,6 (poly(tetramethylene adipamide)), nylon 6 (polycaprolactam), nylon 6,6 (poly(hexamethylene adipamide)), nylon 6,9 (poly(hexamethylene nonanediamide)), nylon 6,10 (poly(hexamethylene sebacamide)), nylon 6,12 (poly(hexamethylene dodecanediamide)), nylon 6/12 (poly(caprolactam-co-do-decanediamide)), nylon 6,6/6 (poly(hexamethylene adipamide-co-caprolactam)), nylon 11 (polyundecanolactam), nylon 12 (polyauryllactam) and alloys or mixtures thereof. Preferably, the sixth layer 22 is a blend of between about 100% (wt.) to about 71% (wt.) of a nylon selected form the group consisting of nylon 4,6 (poly(tetramethylene adipamide)), nylon 6 (polycaprolactam), nylon 6,6 (poly(hexamethylene adipamide)), nylon 6,9 (poly(hexamethylene nonanediamide)), nylon 6,10 (poly(hexamethylene sebacamide)), nylon 6,12 (poly(hexamethylene dodecanediamide)), nylon 6/12 (poly(caprolactam-co-do-decanediamide)), nylon 6,6/6 (poly(hexamethylene adipamide-co-caprolactam)), nylon 11 (polyundecanolactam), nylon 12 (polyauryllactam) and alloys or mixtures thereof; and between about 0% (wt.) to about 29% (wt.) of an amorphous nylon.

The seventh layer 24 of multilayer film structure 10 comprises an adhesive material. The seventh layer 24 functions as an adhesive for bonding the sixth layer 22 and the eighth layer 26 together. Suitable materials for use as an adhesive are selected from a group consisting of modified or unmodified homopolymer or copolymer of polyethylene, especially ethylene copolymers, alkyl acrylates such as methyl acrylate, ethyl acrylate, n-butyl acrylate, or vinyl esters such as vinyl acetate, especially ethylene vinyl acetate copolymers (EVA), ethylene-alpha olefin (EAO) and blends thereof. Preferred adhesives are similar to those useful in the third layer and may include anhydride and/or rubber modified EVAs and EAOs. An example of a commercially available material is sold under the trademark BYNEL® 41E687 from du Pont de Nemours and Company, Wilmington, Del., U.S.A.

The eighth layer 26 comprises a polymer selected from nylon, polyethylene, polypropylene, polyester and blends and copolymers thereof. In one aspect, the eighth layer 26 comprises nylon or a nylon blend. In this aspect, the eighth layer 26 comprises a nylon selected form the group consisting of nylon 4,6 (poly(tetramethylene adipamide)), nylon 6 (polycaprolactam), nylon 6,6 (poly(hexamethylene adipamide)), nylon 6,9 (poly(hexamethylene nonanediamide)), nylon 6,10 (poly(hexamethylene sebacamide)), nylon 6,12 (poly(hexamethylene dodecanediamide)), nylon 6/12 (poly(caprolactam-co-do-decanediamide)), nylon 6,6/6 (poly(hexamethylene adipamide-co-caprolactam)), nylon 11 (polyundecanolactam), nylon 12 (polyauryllactam) and alloys or mixtures thereof. Preferably, the eighth layer 26 is a blend of between about 100% (wt.) to about 71% (wt.) of a nylon selected from the group consisting of nylon 4,6 (poly(tetramethylene adipamide)), nylon 6 (polycaprolactam), nylon 6,6 (poly(hexamethylene adipamide)), nylon 6,9 (poly(hexamethylene nonanediamide)), nylon 6,10 (poly(hexamethylene sebacamide)), nylon 6,12 (poly(hexamethylene dodecanediamide)), nylon 6/12 (poly(caprolactam-co-do-decanediamide)), nylon 6,6/6 (poly(hexamethylene adipamide-co-caprolactam)), nylon 11 (polyundecanolactam), nylon 12 (polyauryllactam) and alloys or mixtures thereof; and between about 0% (wt.) to about 29% (wt.) of an amorphous nylon similar to that disclosed for the fourth and sixth layers 18 and 22.

In another aspect, eighth layer 26 preferably comprises a polyester. As used herein, the term “polyester” refers to a synthetic homopolymers and copolymers having an ester linkage between monomer units which may be formed by condensation polymerization methods. Polymers of this type are preferable aromatic polyesters and more preferable, homopolymers and copolymers of poly(ethylene terephthalate), poly(ethylene naphthalate) and blends thereof. Suitable aromatic polyesters may have an intrinsic viscosity between 0.60 to 1.0, preferably between 0.60 to 0.80. When the eighth layer 26 comprises polyester, it provides superior dimensional stability to the film for subsequent processing, including subsequent thermoforming processes, and can serve as a surface layer in the film structure. Examples of preferred polyesters are available under the trademarks EASTAPAK® PET Polyester 9663, EASTPAK® Polymer 9921 and EASTAR® Copolyester 6763, all from Eastman Chemical Company, Kingsport, Tenn., U.S.A.

In still another aspect, eighth layer 26 preferably comprises polypropylene. An example of a commercially available polypropylene suitable for use in the present invention is sold under the trademark BP Amoco ACCLEAR® 6219 from Innovene, Chicago, Ill., U.S.A.

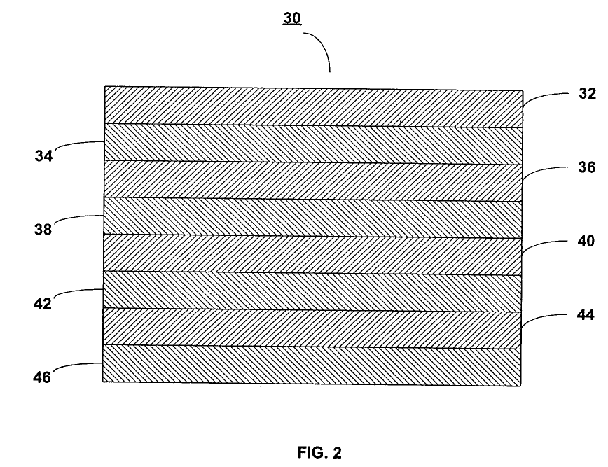

Small amounts of additives such as slip or anti-block agents, pigments, processing aids and the like can be included in any of the layers in the multilayer film structure 10 or in any layers further added to this structure which is formed into a flexible film. Similarly, such additives may also be include in any of the layers discussed below in connection with multilayer film structures 30, 50, and 70 illustrated in FIGS. 2-4 respectively.

Turning now to FIG. 2, there is illustrated a multilayer film structure 30 having a first layer 32, a second layer 34, a third layer 36, a fourth layer 38, a fifth layer 40, a sixth layer 42, a seventh layer 44 and an eighth layer 46. First layer 32, second layer 34, third layer 36, fourth layer 38, sixth layer 42, seventh layer 44 and eighth layer 46 may be selected from the same materials as disclosed in connection with their counterparts in multilayer film structure 10 discussed above. In multilayer film structure 30, the fifth layer 40 comprises an adhesive material. The fifth layer 40 functions as an adhesive for bonding the fourth layer 38 and the sixth layer 42 together. Suitable materials for use as an adhesive are selected from a group consisting of modified or unmodified homopolymer or copolymer of polyethylene, especially ethylene copolymers, alkyl acrylates such as methyl acrylate, ethyl acrylate, n-butyl acrylate, or vinyl esters such as vinyl acetate, especially ethylene vinyl acetate copolymers (EVA), ethylene-alpha olefin (EAO) and blends thereof. Preferred adhesives are similar to those useful in the third layer and may include anhydride and/or rubber modified EVAs and EAOs. An example of a commercially available material is sold under the trademark BYNEL® 41E687 from du Pont de Nemours and Company, Wilmington, Del., U.S.A.

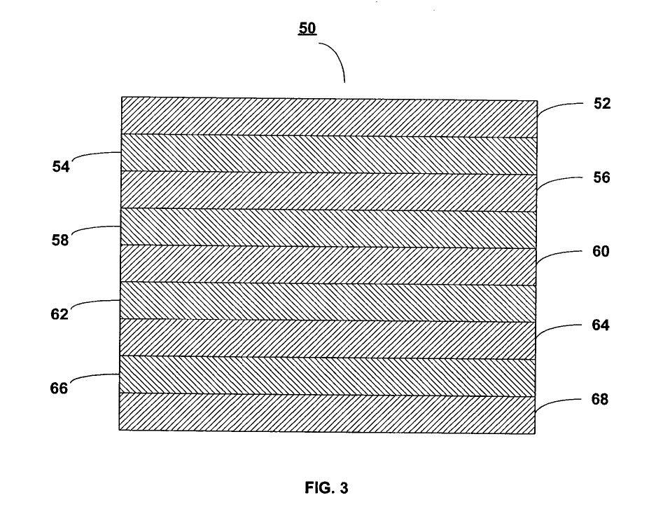

In FIG. 3, a nine-layer film structure 50 is shown having a first layer 52, a second layer 54, a third layer 56, a fourth layer 58, a fifth layer 60, a sixth layer 62, a seventh layer 64, an eighth layer 66 and a ninth layer 68. The fourth layer 58, fifth layer 60, sixth layer 62, seventh layer 64, eighth layer 66 and ninth layer 68 correspond to and may be selected according to the disclosure of the third through eighth layer 16-26 of multilayer film structure 10 above. The composition of the first layer 52 and second layer 54 also correspond to and may be selected from the materials disclosed above for the first layer and second layer 12 and 14 of multilayer film structure 10. Structure 50 includes third layer 56 comprising a polyolefin. Polyolefin broadly includes polymers such as polyethylene, ethylene copolymers having a small amount of a copolymer such as vinyl acetate, ethylene-alpha olefin copolymers (LLDPE), polypropylene, polybutene, and blends and copolymers thereof and other polymeric resins falling in the “olefin” family classification.

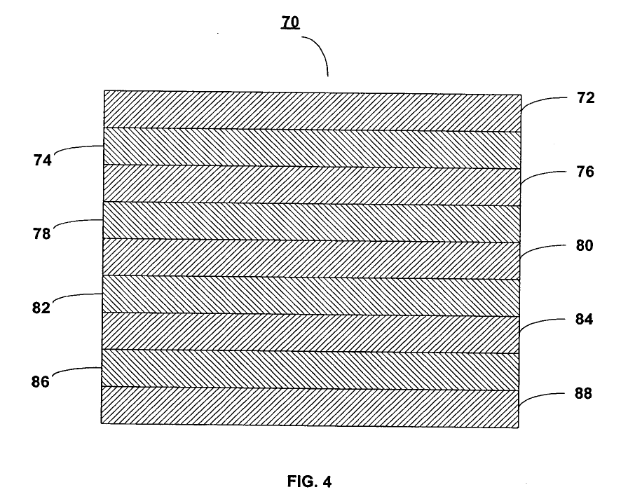

Turning now to FIG. 4, there is shown a multilayer film structure 70 having a first layer 72, a second layer 74, a third layer 76, a fourth layer 78, a fifth layer 80, a sixth layer 82, a seventh layer 84, an eighth layer 86 and a ninth layer 88. The fourth layer 78, fifth layer 80, sixth layer 82, seventh layer 84, eighth layer 86 and ninth layer 88 correspond to and may be selected according to the disclosure of the third through eighth layers 36-46 of multilayer film structure 30 above. The composition of the first layer 72 and second layer 74 also correspond to and may be selected from the materials disclosed above for the first layer and second layer 12 and 14 of multilayer film structure 10. Multilayer film structure 70 also includes a third layer 76 comprising a polyolefin.

The multilayer film structures 10, 30, 50 and 70 formed into a flexible film preferably are non-oriented and have a heat shrinkage value of less than about 5% at 90° C., preferably less than about 2% at 90° C. Heat shrinkage test is defined to be values obtained by measuring unrestrained shrink at 90° C. for five seconds. Four test specimens are cut to 10 cm. in the machine direction by 10 cm. in the transverse direction. Each specimen is completely immersed for 5 seconds in a 90° C. water bath (or other specified non-reactive liquid). The distance between the ends of the shrunken specimen is measured. The difference in the measured distance for the shrunken specimen and the original 10 cm. is multiplied by ten to obtain the percent of shrinkage for the specimen for each direction. The machine direction shrinkage for the four specimens is averaged for the machine direction shrinkage value of the given film sample, and the transverse direction shrinkage for the four specimens is averaged for the transverse direction shrinkage value.

It is also preferred that the multilayer film structures 10, 30, 50 and 70 formed into a flexible film have an elongation at break at room temperature of greater than about 250% in either or both the machine direction and in the transverse direction. The percent elongation at break may be measured by following the procedure as outlined by ASTM D-882, Method A, which method is hereby incorporated by reference.

According to the present disclosure, the multilayer film structures may advantageously be formed into a flexible film containing less than 500 ppm of a transition-metal salt selected from the group consisting of manganese II, manganese III, iron II, iron III, cobalt II, cobalt III, nickel II, nickel III, copper I, copper II, rhodium II, rhodium III, rhodium IV, and ruthenium.

Advantageously, the flexible films formed from multilayer film structures 10, 30, 50 and 70 of this disclosure provide superior optical properties, i.e., high gloss and low haze. Gloss may be measured using the test method described by ASTM D-2457 at a 45° angle which method is hereby incorporated by reference. According to the present invention, the multilayered structure 10 formed into a film has a gloss value greater than about 65 Hunter Units (HU).

While the present disclosure has described in detail embodiments having eight and nine layers, one of skill in the art will appreciate that additional layers may optionally be coextruded between any of the third layers through nine layers, and optionally to the exterior of the eighth and ninth layers, i.e., the eighth and ninth layers become internal layers with other layers adjacent those layers on the side opposite the first layer. In this regard, any number of layers may be provided so long as the interfacial stability is maintained by formation of the first and second layers as outlined above.

Multilayer film structures 10, 30, 50 and 70 are formed via a coextrusion process. Multilayer film structures may be formed by combining different streams of melt-plastified polymers into a single structure by slot or flat cast or blown bubble coextrusion. The flat die or slot cast process includes extruding polymer streams through a flat or slot die onto a chilled roll and subsequently winding the film onto a core to form a roll of film for further processing. In the blown bubble coextrusion process, streams of melt-plastified polymers are forced through an annular die having a central mandrel to form a tubular extrudate. The tubular extrudate is preferably expanded to a desired wall thickness by a volume of air or other gas entering the hollow interior of the extrudate via the mandrel, and then rapidly cooled or quenched by any of various methods known to those of skill in the art.

Preferably, the films of the present disclosure, such as multilayer film structures 10, 30, 50 and 70, are formed using a single-bubble blown film apparatus and method. The single-bubble blown film apparatus includes a multi-manifold annular die head for bubble blown film through which the film composition is forced and formed into a substantially cylindrical bubble. The bubble is immediately quenched, e.g., via cooled water bath, solid surface and/or air, and then ultimately collapsed and formed into a film. Each layer is melt-plastified in a separate extruder (although a single extruder may supply the same composition to multiple layers) connected to the annular coextrusion die from which the heat plastified layers are coextruded forming the tube or bubble.

In accordance with the present disclosure, the multilayered structures 10, 30, 50 and 70 formed into a flexible film have a thickness less than about 15 mils., more preferably less than about 7 mils., and most preferably, from about 3 mils. to about 5 mils. The first layers 12, 32, 52, and 72 have a total thickness of less than 0.25 mils. and preferably comprise from about 1% to about 10% of the total film thickness, with the first layers 12, 32, 52 and 72 having a thickness uniformity deviation of less than about 20% of the average thickness of the first layer.

The multilayer film structures are preferably formed into packages by heat sealing with a second structure including a heat sealable material that forms a bond with the first layer having a strength greater than the weakest bond strength between the first and second layers, the second and third layers, or the internal cohesive strength of the second layer. As such, when the multilayer film structure is manually peeled from the second structure, the first layer remains sealed to the second structure in the area of the heat seal, and fractures such that the peel failure propagates internally within the zone from the first layer/second layer interface to the second layer/third layer interface. Preferably, the second structure does not include an internal frangible failure mechanism, but packages may be forming package walls from two separate multilayer films structures according to the present disclosure or folding a single sheet as known by those of skill in the art. Advantageously, packages may be formed from a single supply of multilayer films structures according to the present disclosure by incorporating lap seals, i.e., the first layer is heat-sealed to a compatible opposite exterior layer.

Applicants have found that the multilayer film structures disclosed herein overcome the deficiencies of the prior art multilayer film structures including an internal frangible failure mechanism. Prior structures incorporating a frangible adhesive layer adjacent to internal nylon layers required sealant and frangible adhesive layers of excessive thickness to overcome interfacial instability problems between those layers. Interfacial instability leads to undesirable optical characteristics such as haze and loss of clarity. Increased layer thickness for the sealant layer and frangible adhesive layer creates non-uniform failures and can lead to stringing or webbing of the film when manually pealed from a second film. The applicants have overcome these problems by providing an intermediate layer between the frangible adhesive layer and the third layer, which allows the multilayer film structures to incorporate optimum thickness ratios for the first layer and the frangible adhesive layer.

The disclosure will now be further described in the following non-limiting example:

In the following examples, all film structures are produced using a single-bubble coextrusion apparatus and method. The single-bubble blown film apparatus includes a multi-manifold annular die head for blown bubble film through which the film composition is forced and formed into a cylindrical tube or bubble. The bubble is immediately quenched, e.g., via cooled water bath, solid surface and/or air, and then ultimately collapsed and formed into a film.

### EXAMPLES

The following resins are coextruded in the following structural relationship in accordance with FIG. 3:

Layer 52: first layer or sealant comprising 97% (wt.) linear low-density polyethylene (DOWLEX® 3010, The Dow Chemical Company, Midland, Mich., U.S.A.) and 3% (wt.) antiblock, slip and processing additives and consisting of 1.8% of total weight of multilayer film structure 50;

Layer 54: second layer or frangible adhesive layer comprising 85% (wt.) EVA (Equistar NA442-051, Equistar Chemicals, LP, Houston, Tex., U.S.A.) and 15% (wt.) polybutylene (Shell 8640, Shell Chemicals USA, Houston, Tex., U.S.A.) and consisting of 6.3% of the total weight of multilayer film structure 50;

Layer 56: third layer of polyolefin comprising 100% (wt.) ULDPE (ATTANE® 4201G, The Dow Chemical Company, Midland, Mich., U.S.A.);

Layer 58: fourth layer of adhesive consisting of 12.6% of the total weight of multilayer film structure 50;

Layer 60: fifth layer of nylon blend comprising 85% nylon 6 having a density of 1.12 g/cm³, a melting point of a 220° C., a recrystallization temperature (as measured by deferential scanning calorimetry (DSC)) of 176° C., being available under the trademark ULTRAMID® B36 from BASF Corporation, Mount Olive, N.J., U.S.A.; and 15% (wt.) of an amorphous nylon having a density of 1.19 g/cm³, a glass transition temperature of 127° C., a heat deflection temperature at 66 psi of 126° C., and is sold under the trademark SELAR® PA 3426 by du Pont de Nemours and Company, Wilmington, Del., U.S.A., consisting of 14.7% of the total weight of multilayer film structure 50;

Layer 62: sixth layer or oxygen barrier comprising ethylene vinyl alcohol copolymer (EVOH) having a reported bulk density of 0.64-0.74 g/cm³, a relative density of 1.13-1.22 g/cm³, a melting point of 164-188° C., and is available under the trademark SOARNOL® ET 3803 from the Nippon Synthetic Chemical Industry Company, Ltd. (Nippon Gohsei), Osaka, Japan, consisting of 9.4% of the total weight of multilayer film structure 50;

Layer 64: seventh layer of nylon comprising same blend and weight percentage as layer 60 above;

Layer 66: eighth layer of adhesive consisting of 14.6% of the total weight of multilayer film structure 50;

Layer 68: ninth layer comprising a nylon blend of 77% (wt) ULTRAMID® B36 nylon 6, 15% (wt.) SELAR® PA 3426 and 8% (wt.) antiblock, slip and processing additives.

One extruder is used for each layer. Each extruder is connected to an annular coextrusion die from which heat plastified resins are coextruded forming a tube or single-bubble having seven layers. The resin or resin mixture is fed from a hopper into an attached single screw extruder where the heat plastified resin is formed and is subsequently extruded through a nine-layer coextrusion die into a tube or single-bubble. The bubble is maintained at a width of less than 53 inches. The extruded multilayer bubble is quenched against a cooled solid surface. The cooled bubble is flattened by passage through a pair of nip rollers and the resultant film has an average gauge between 3 mil to 5 mil.

While various embodiments of the disclosure are herein described, it is envisioned that those skilled in the art may devise various modifications and equivalents without departing from the spirit and scope of the disclosure. The disclosure is not intended to be limited by the foregoing detailed description.

What is claimed is:

1. A multilayer coextruded thermoplastic film structure comprising:
a) a first layer comprising a polymer sealant material;
b) a second layer comprising a frangible polymer blend;
c) a third layer comprising an adhesive material;
d) a fourth layer comprising a nylon;
e) a fifth layer comprising a member selected from the group consisting of an adhesive material and an oxygen gas barrier material;
f) a sixth layer comprising a nylon;
g) a seventh layer comprising an adhesive material; and
h) an eighth layer comprising a member selected from the group consisting of polyethylene, polypropylene, polyester, nylon and blends and copolymers thereof;
wherein said first layer is coextruded with said second through eighth layers, said first layer comprises from about 1% to about 10% of the total thickness of said coextruded film structure, said first layer has a thickness uniformity deviation of less than about 20% of the average thickness of said first layer; said second layer has a maximum thickness of about 0.5 mils.; and said multilayer film structure has a peel strength of less than 2000 grams per inch as measured in accordance with ASTM F-904 test method when peeled from a second film structure to which said multilayer film structure has been heat-sealed.

2. A multilayer film structure according to claim 1, wherein said film is produced by slot cast or single-bubble blown coextrusion.

3. The multilayer film structure according to claim 1, wherein said first layer is an exterior surface layer of said film and has a thickness of less than about 0.15 mils.

4. The multilayer film structure according to claim 1, wherein said second layer is directly adhered to said first layer.

5. The multilayer film structure according to claim 1, wherein said film has a thickness of less than about 15 mils.

6. The multilayer film structure according to claim 5, wherein said film has a thickness of less than about 10 mils.

7. The multilayer film structure according to claim 6, wherein said film has a thickness of between 3-7 mils.

8. The multilayer film structure according to claim 1, wherein said film has heat shrinkage value less than about 5% in the machine direction at 90° C. and less than about 5% in the transverse direction at 90° C., as measured in accordance with ASTMD-2732-96 test method.

9. The multilayer film structure according to claim 8, wherein said film has a heat shrinkage value less than about 2% in the machine direction at 90° C. and less than about 2% in the transverse direction at 90° C. as measured in accordance with ASTMD-2732-96 test method.

10. The multilayer film structure according to claim 1, wherein said film contains less than 500 ppm of a transition-metal salt selected from the group consisting of manganese II, manganese III, iron II, iron III, cobalt II, cobalt III, nickel II, nickel III, copper I, copper II, rhodium II, rhodium II, rhodium IV, and ruthenium.

11. The multilayer film structure according to claim 1, wherein said film has a gloss value greater than about 65 Hunter Units (HU) as measured in accordance with ASTM D-523 test method.

12. The multilayer film structure according to claim 1, wherein said eighth layer comprises polyester selected from the group consisting of a homopolymer or copolymer of an aromatic ester and a blend thereof.

13. The multilayer film structure according to claim 12, wherein said eighth layer is selected from the group consisting of a homopolymer or copolymer of ethylene terephthalate, ethylene naphthalate and blends thereof.

14. The multilayer film structure according to claim 1, wherein said film comprises processing additives.

15. The multilayer film structure according to claim 1, wherein said frangible polymer blend comprises a first polymeric component selected from the group consisting of polyethylene, EVA, ionomer, adhesive material and blends thereof and a second polymeric component selected from the group consisting of polybutylene, polypropylene, high-density polyethylene and blends thereof.

16. The multilayer film structure according to claim 15, wherein said adhesive material is selected from the group consisting of a modified or unmodified homopolymer or copolymer of ethylene, methyl acrylate, ethyl acrylate, n-butyl acrylate, ethylene vinyl acetate, ethylene vinyl acetate copolymers, ethylene-alpha olefins and blends thereof.

17. The multilayer film structure according to claim 1, wherein said eighth layer is a nylon selected from the group consisting of nylon 4,6 (poly(tetramethylene adipamide)), nylon 6 (polycaprolactam), nylon 6,6 (poly(hexamethylene adipamide)), nylon 6,9 (poly(hexamethylene nonanediamide)), nylon 6,10 (poly(hexamethylene sebacamide)), nylon 6,12 (poly(hexamethylene dodecanediamide)), nylon 6/12 (poly(caprolactam-co-dodecanediamide)), nylon 6,6/6 (poly(hexamethylene adipamide-co-caprolactam)), nylon 11 (polyundecanolactam), nylon 12 (polyauryllactam) and alloys or mixtures thereof.

18. The multilayer film structure according to claim 17, wherein said eighth layer is a blend between about 100% (wt.) to about 71% (wt.) of a nylon selected from the group consisting of nylon 4,6 (poly(tetramethylene adipamide)), nylon 6 (polycaprolactam), nylon 6,6 (poly(hexamethylene adipamide)), nylon 6,9 (poly(hexamethylene nonanediamide)), nylon 6,10 (poly(hexamethylene sebacamide)), nylon 6,12 (poly(hexamethylene dodecanediamide)), nylon 6/12 (poly(caprolactam-co-dodecanediamide)), nylon 6,6/6 (poly(hexamethylene adipamide-co-caprolactam)), nylon 11 (polyundecanolactam), nylon 12 (polyauryllactam) and alloys or mixtures thereof; and between about 0% (wt.) to about 29% (wt.) of an amorphous nylon.

19. The multilayer film structure according to claim 1, wherein said fifth layer is an oxygen gas barrier selected from ethylene vinyl alcohol copolymer, polyvinylidene chloride copolymers, polyacrylonitrile, acrylonitrile copolymer, and blends thereof.

20. The multilayer film structure according to claim 1, wherein said fourth and sixth layers are each independently selected form the group consisting of nylon 4,6 (poly(tetramethylene adipamide)), nylon 6 (polycaprolactam), nylon 6,6 (poly(hexamethylene adipamide)), nylon 6,9 (poly(hexamethylene nonanediamide)), nylon 6,10 (poly(hexamethylene sebacamide)), nylon 6,12 (poly(hexamethylene dodecanediamide)), nylon 6/12 (poly(caprolactam-co-dodecanediamide)), nylon 6,6/6 (poly(hexamethylene adipamide-co-caprolactam)), nylon 11 (polyundecanolactam), nylon 12 (polyauryllactam) and alloys or mixtures thereof.

21. The multilayer film structure according to claim 20, wherein said fourth and sixth layers each independently comprises a blend between about 100% (wt.) to about 71% (wt.) of a nylon selected from the group consisting of nylon 4,6 (poly(tetramethylene adipamide)), nylon 6 (polycaprolactam), nylon 6,6 (poly(hexamethylene adipamide)), nylon 6,9 (poly(hexamethylene nonanediamide)), nylon 6,10 (poly(hexamethylene sebacamide)), nylon 6,12 (poly(hexamethylene dodecanediamide)), nylon 6/12 (poly(caprolactam-co-dodecanediamide)), nylon 6,6/6 (poly(hexamethylene adipamide-co-caprolactam)), nylon 11 (polyundecanolactam), nylon 12 (polyauryllactam) and alloys or mixtures thereof; and between about 0% (wt.) to about 29% (wt.) of an amorphous nylon.

22. The multilayer film structure according to claim 1, wherein said gas barrier is such that said film has an oxygen transmission rate less than about 15.5 cc/m² for 24 hours at 1 atmosphere as measured in accordance with ASTM D-3985 test method.

23. The multilayer film structure according to claim 15, wherein said second polymeric component is polybutylene.

24. The multilayer film structure according to claim 23, wherein said first polymeric component comprises from about 70% to about 95% by weight of said second layer.

25. The multilayer film structure according to claim 1, wherein said second layer comprises a blend of about 85% by weight of a first polymeric component and 15% by weight of polybutylene.

26. The multilayer film structure according to claim 1, wherein said third layer and said seventh layer are each independently selected from the group consisting of modified or unmodified homopolymer or copolymer of polyethylene, methyl acrylate, ethyl acrylate, n-butyl acrylate, ethylene vinyl acetate, ethylene vinyl acetate copolymers, ethylene-alpha olefin and blends thereof.

27. The multilayer film structure according to claim 1, wherein said structure has a peel strength of less than about 2000 grams per inch as measured in accordance with ASTM F-904 test method when peeled from a second film structure to which said multilayer film structure has been heat-sealed.

28. The multilayer film structure according to claim 27, wherein said peel strength is less than about 1500 grams per inch as measured in accordance with ASTM F-904 test method.

29. The multilayer film structure according to claim 28, wherein said peel strength is between about 500 grams per inch to about 1000 grams per inch as measured in accordance with ASTM F-904 test method.

30. The multilayer film structure according to claim 1, wherein said first layer is selected from a group consisting of ionomer, polyethylene, heterogeneous ethylene-alpha olefin copolymer, homogeneous ethylene-alpha olefin copolymer, low-density polyethylene, linear low-density polyethylene and ultra low-density polyethylene, ethylene vinyl acetate copolymer, ethylene methyl acrylate copolymer, ethylene propylene copolymer, polypropylene homopolymer and copolymer, polybutylene homopolymer and copolymer, propylene-alpha olefin copolymers, polyethylene terephthalate, nylon, and blends thereof.

31. The multilayer film structure according to claim 1, wherein said film has an elongation at break at room temperature greater than about 250% in the machine direction and greater than about 250% in the transverse direction as measured in accordance with ASTM D-2732-96 test method.

32. The multilayer film structure according to claim 1, further including a ninth layer coextruded between said second layer and said third layer, said ninth layer comprising either a polyolefin or an adhesive material.

33. The multilayer film structure according to claim 32, wherein said ninth layer is a polyolefin selected from the group consisting of polyethylene, ethylene vinyl acetate, ethylene-alpha olefin copolymers, polypropylene, polybutene, and blends and copolymers thereof.

34. A multilayer coextruded film structure including an internal failure mechanism comprising:
a) a first layer comprising from about 1% to about 10% of the total thickness of said multilayer coextruded film structure formed of a polymer sealant material, said first layer having a maximum thickness of 0.25 mils. and having a thickness uniformity deviation of less than about 20% based on the average thickness of said first layer;
b) a second layer coextruded adjacent to said first layer and comprising a first polymeric component selected from the group consisting of polyethylene, EVA, ionomer, adhesive material and blends thereof and a second polymeric component selected from the group consisting of polybutylene, polypropylene, high-density polyethylene and blends thereof, said second layer having a maximum thickness of about 0.5 mils.;
c) a third layer coextruded adjacent to said second layer, said third layer comprising a member selected from the group consisting of a modified or unmodified homopolymer or copolymer of ethylene, methyl acrylate, ethyl acrylate, n-butyl acrylate, ethylene vinyl acetate, ethylene vinyl acetate copolymers, ethylene-alpha olefins and blends thereof;
d) a fourth layer coextruded adjacent to said third layer, said fourth layer comprising a member selected from the group consisting of an adhesive material and a polyolefin;
e) a fifth layer coextruded adjacent to said fourth layer, said fifth layer comprising a nylon selected from the group consisting of nylon 4,6 (poly(tetramethylene adipamide)), nylon 6 (polycaprolactam), nylon 6,6 (poly(hexamethylene adipamide)), nylon 6,9 (poly(hexamethylene nonanediamide)), nylon 6,10 (poly(hexamethylene sebacamide)), nylon 6,12 (poly(hexamethylene dodecanediamide)), nylon 6/12 (poly(caprolactam-co-dodecanediamide)), nylon 6,6/6 (poly(hexamethylene adipamide-co-caprolactam)), nylon 11 (polyundecanolactam), nylon 12 (polyauryllactam) and alloys or mixtures thereof;
f) a sixth layer coextruded adjacent to said fifth layer, said sixth layer comprising a member selected from the group consisting of adhesive material and oxygen gas barrier material;
g) a seventh layer coextruded adjacent to said sixth layer, said seventh layer comprising a nylon selected form the group consisting of nylon 4,6 (poly(tetramethylene adipamide)), nylon 6 (polycaprolactam), nylon 6,6 (poly(hexamethylene adipamide)), nylon 6,9 (poly(hexamethylene nonanediamide)), nylon 6,10 (poly(hexamethylene sebacamide)), nylon 6,12 (poly(hexamethylene dodecanediamide)), nylon 6/12 (poly(caprolactam-co-do-decanediamide)), nylon 6,6/6 (poly(hexamethylene adipamide-co-caprolactam)), nylon 11 (polyundecanolactam), nylon 12 (polyauryllactam) and alloys or mixtures thereof;
h) an eighth layer coextruded adjacent to said seventh layer, said eighth layer comprising an adhesive selected from the group consisting of a modified or unmodified homopolymer or copolymer of ethylene, methyl acrylate, ethyl acrylate, n-butyl acrylate, ethylene vinyl acetate, ethylene vinyl acetate copolymers, ethylene-alpha olefins and blends thereof; and,
i) a ninth layer coextruded adjacent to said eighth layer, said ninth layer comprising a member selected from the group consisting of polyethylene, polypropylene, polyester, nylon and blends and copolymers thereof;
wherein said multilayer coextruded film structure has a total thickness from about 2 to about 15 mils., and said multilayer coextruded film structure has a heat shrinkage value less than about 5% in the machine direction at 90° C. and less than about 5% in the transverse direction at 90° C. as measured in accordance with ASTM D-2732-96 test method.

35. The multilayer coextruded film structure according to claim 34, wherein said first layer is an outer-surface layer of said film and has a thickness of less than about 0.15 mils.

36. The multilayer film structure according to claim 32 or 34, wherein said adhesive material is selected from the group consisting of modified or unmodified homopolymer or copolymer of polyethylene, methyl acrylate, ethyl acrylate, n-butyl acrylate, ethylene vinyl acetate, ethylene vinyl acetate copolymers, ethylene-alpha olefin and blends thereof.
